(19) United States
(12) Patent Application Publication
(10) Pub. No.: US 2008/0259234 A1
(43) Pub. Date: Oct. 23, 2008

(54) Liquid crystal display device and method for driving same

(75) Inventors: Yu-Cheng Lin, Miao-Li (TW); Chun-Yung Chi, Miao-Li (TW); Chueh-Ju Chen, Miao-Li (TW); Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/148,660

(22) Filed: Apr. 21, 2008

(30) Foreign Application Priority Data
Apr. 20, 2007 (CN) 200710074129.7

(51) Int. Cl. G02F 1/133; G09G 3/36

(52) U.S. Cl. 349/38; 349/33

(57) ABSTRACT

An exemplary liquid crystal display device includes a plurality of gate lines configured for providing a plurality of scanning signals, a plurality of data lines configured for providing a plurality of gray scale voltages, and a plurality of pixel units arranged in an array. Each pixel unit includes a first sub-pixel unit and a second sub-pixel unit. The first and second sub-pixel units are connected to one of the gate lines and one of the data lines. A plurality of first common lines are configured for providing a first common signal to the first sub-pixel unit, and a plurality of second common lines are configured for providing a second common signal to the second sub-pixel unit. The first and second common signals are pulse voltage signals and have different starting pulse times according to successive starting pulse times of the scanning signals. An exemplary method for driving the liquid crystal display device is also provided.

### FIELD OF THE INVENTION

The present invention relates to liquid crystal display (LCD) devices, and particularly to a vertical alignment mode LCD device having two different sub-pixel units in each pixel unit thereof. The present invention also relates to a method for driving the LCD device.

### GENERAL BACKGROUND

Since LCD devices are thin and light, consume relatively little electrical power, and do not cause flickering like in cathode ray tube (CRT) display devices, they have helped spawn product markets such as laptop personal computers. In recent years, there has also been great demand for LCD devices to be used as computer monitors and even televisions, both of which are typically larger than the LCD devices of laptop personal computers. Such large-sized LCD devices in particular require that an even brightness and contrast ratio prevail over the entire display surface, regardless of observation angle.

Because the conventional twisted nematic (TN) mode LCD device cannot easily satisfy these demands, a variety of improved LCD devices have recently been developed. They include in-plane switching (IPS) mode LCD devices, optical compensation TN mode LCD devices, and multi-domain vertical alignment (MVA) mode LCD devices. In multi-domain vertical alignment mode LCD devices, each pixel unit is divided into multiple regions. Liquid crystal molecules of the pixel unit are vertically aligned when no voltage is applied, and are inclined in different directions when a voltage is applied.

Referring to FIG. 5, part of a typical multi-domain vertical alignment mode LCD device is shown. The LCD device 1 includes a first substrate 11, a second substrate 12 parallel to the first substrate 11, and a liquid crystal layer 13 sandwiched between the first substrate 11 and the second substrate 12. A common electrode 111 is disposed on an inner surface of the first substrate 11, and a pixel electrode 121 is disposed on an inner surface of the second substrate 12. A plurality of protrusions 14 are formed on a surface of the common electrode 111 adjacent to the liquid crystal layer 13, and a plurality of slits 15 are formed in the pixel electrode 121. Liquid crystal molecules of the liquid crystal layer 13 are inclined in different directions when a voltage is applied.

Referring also to FIG. 6, a pixel unit 10 of the LCD device 1 is shown. The LCD device 1 further includes a multiplicity of gate lines 16, and a multiplicity of data lines 17 orthogonal to the gate lines 16. The pixel unit 10 includes a first sub-pixel unit 18 and a second sub-pixel unit 19. The first sub-pixel unit 18 includes a first thin film transistor (TFT) 181, a first liquid crystal capacitor 182, a first storage capacitor 183, and a first common voltage input terminal 184. The second sub-pixel unit 19 includes a second TFT 191, a second liquid crystal capacitor 192, a second storage capacitor 193, and a second common voltage input terminal 194. In the first sub-pixel unit 18, the common electrode 111, the pixel electrode 121, and a portion of the liquid crystal layer 13 therebetween constitute the first liquid crystal capacitor 182. In the second sub-pixel unit 19, the common electrode 111, the pixel electrode 121, and a portion of the liquid crystal layer 13 therebetween constitute the second liquid crystal capacitor 192. Gate electrodes (not labeled) of the first and second TFTs 181, 191 are connected to a corresponding one of the gate lines 16 that runs between the first and second sub-pixel units 18, 19. Drain electrodes (not labeled) of the first and second TFTs 181, 191 are connected to a corresponding one of the data lines 17. Source electrodes of the first and second TFTs 181, 191 are connected to the pixel electrode 121. One electrode (not labeled) of the first storage capacitor 183 is connected to the pixel electrode 121, and the other electrode (not labeled) of the first storage capacitor 183 is connected to the first common voltage input terminal 184. One electrode (not labeled) of the second storage capacitor 193 is connected to the pixel electrode 121, and the other electrode (not labeled) of the second storage capacitor 193 is connected to the second common voltage input terminal 194.

The gate line 16 is used for applying a scanning signal to the first and second TFTs 181, 191 in order to switch on or switch off the first and second TFTs 181, 191. The data line 17 is used for applying a gray scale voltage to the drain electrodes of the first and second TFTs 181, 191. The first and second common voltage input terminals 184, 194 are used for applying common voltages to the first and second storage capacitors 183, 193, respectively. The common voltages are equal to a voltage applied to the common electrode 111.

When the first and second TFTs 181, 191 are switched on, the gray scale voltage is applied to the first and second sub-pixel units 18, 19 via the first and second TFTs 181, 191. Because the voltage applied to the common electrode 111 remains constant, the common voltages applied to the first and second storage capacitors 183, 193 remain constant. Thus the liquid crystal molecules in the first and second sub-pixel units 18, 19 are all inclined at a same angle with respect to each of the substrates 11, 12, and a color shift phenomenon is apt to occur when the LCD device 1 is viewed from different locations.

What is needed, therefore, is an LCD device that can overcome the above-described deficiencies. What is also needed is a method for driving an LCD device that can overcome the above-described deficiencies.

### SUMMARY

In one aspect, an exemplary liquid crystal display device includes a plurality of gate lines configured for providing a plurality of scanning signals, a plurality of data lines configured for providing a plurality of gray scale voltages, and a plurality of pixel units arranged in an array. Each pixel unit includes a first sub-pixel unit and a second sub-pixel unit. The first and second sub-pixel units are connected to one of the gate lines and one of the data lines. A plurality of first common lines are configured for providing a first common signal to the first sub-pixel unit, and a plurality of second common lines are configured for providing a second common signal to the second sub-pixel unit. The first and second common signals are pulse voltage signals and have different starting pulse times according to successive starting pulse times of the scanning signals.

In another aspect, an exemplary liquid crystal display device includes a plurality of gate lines configured for providing a plurality of scanning signals, a plurality of data lines configured for providing a plurality of gray scale voltages, and a plurality of pixel units arranged in an array. Each pixel unit includes a first sub-pixel unit and a second sub-pixel unit. The first and second sub-pixel units are connected to one of the gate lines and one of the data lines. A plurality of first common lines are configured for providing a first common signal to the first sub-pixel unit, and a plurality of second common lines are configured for providing a second common signal to the second sub-pixel unit. The first and second common signals are pulse voltage signals, and when a scanning signal is provided to one of the gate lines, a pulse voltage of the first common signal is generated, and when a scanning signal is provided to a next adjacent one of gate lines, a pulse voltage of the second common signal is generated.

In still another aspect, an exemplary method for driving a liquid crystal display device includes: providing a plurality of pixel units arranged in an array, each pixel unit including a first sub-pixel unit and a second sub-pixel unit; providing a plurality of gate lines, a plurality of data lines, a plurality of first common lines, and a plurality of second common lines, with each of the pixel units connected to one of the gate lines, one of the data lines, one of first common lines, and one of second common lines; providing a plurality of scanning signals to the pixel units via the gate lines; providing a plurality of gray scale voltages to the pixel units via the data lines; providing a first common signal to the first sub-pixel units via the first common lines; and providing a second common signal to the second sub-pixel units via the second common lines. The first and second common signals are pulse voltage signals and have different starting pulse times according to successive starting pulse times of the scanning signals.

Other novel features, advantages and aspects will become more apparent from the following detailed description when taken in conjunction with the accompanying drawings.

### BRIEF DESCRIPTION OF THE DRAWINGS

FIG. 1 is an abbreviated circuit diagram of data lines, gate lines and common voltage lines of an LCD device according to an exemplary embodiment of the present invention, the LCD device defining a plurality of pixel units.

FIG. 2 is an enlarged circuit diagram of one of the pixel units of FIG. 1.

FIG. 3 is an abbreviated timing diagram of driving signals applied to the LCD device of FIG. 1.

FIG. 4 is an abbreviated timing diagram of driving signals applied to the pixel unit of FIG. 2.

FIG. 5 is a schematic, side cross-sectional view of part of a conventional LCD device, the LCD device including a plurality of pixel units.

FIG. 6 is a circuit diagram of one of the pixel units of FIG. 5.

### DETAILED DESCRIPTION OF PREFERRED EMBODIMENTS

Reference will now be made to the drawings to describe preferred and exemplary embodiments in detail.

Referring to FIG. 1, an abbreviated circuit diagram of data lines, gate lines and common voltage lines of an LCD device according to an exemplary embodiment of the present invention is shown. The LCD device 2 is a multi-domain vertical alignment mode LCD device. The LCD device 2 includes a plurality of gate lines G1, G2, . . . , Gm (wherein m is a natural number) parallel to each other, a plurality of data lines D1, D2, . . . , Dn (wherein n is a natural number) parallel to each other and orthogonal to the gate lines G1˜Gm, a plurality of first common lines ComA parallel to the gate lines G1˜Gm, and a plurality of second common lines ComB parallel to the gate lines G1˜Gm. The first common lines ComA and the second common lines ComB are disposed alternately, with one of the gate lines disposed between each two adjacent first and second common lines ComA, ComB. A smallest area cooperatively defined by one first common line ComA, one second common line ComB adjacent to the first common line ComA, and two adjacent data lines is defined as a pixel unit 20.

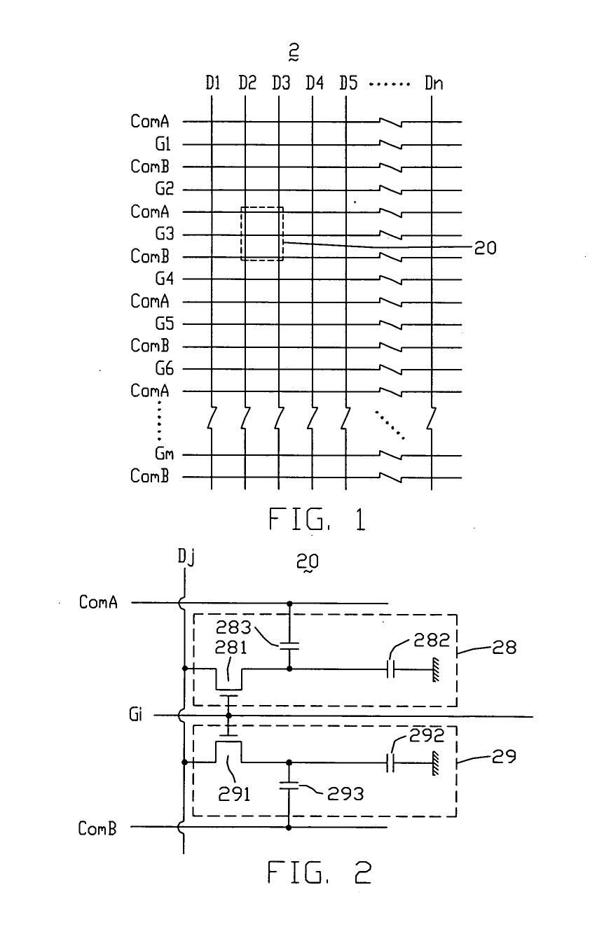

Referring to FIG. 2, an enlarged circuit diagram of one of the pixel units 20 is shown. The pixel unit 20 includes a first sub-pixel unit 28 and a second sub-pixel unit 29. The first sub-pixel unit 28 includes a first TFT 281, a first storage capacitor 283, and a liquid crystal capacitor 282. The second sub-pixel unit 29 includes a second TFT 291, a second storage capacitor 293, and a liquid crystal capacitor 292. The first sub-pixel unit 28 essentially corresponds to one part of a display area of the pixel unit 20, and the second sub-pixel unit 29 corresponds to another part of the display area of the pixel unit 20. An actual area ratio of the first sub-pixel unit 28 relative to the second sub-pixel unit 29 in an area of a liquid crystal panel of the LCD device 2 may be 1:3. Gate electrodes (not labeled) of the first and second TFTs 281, 291 are connected to a corresponding gate line G1 (1≦i≦m), and drain electrodes (not labeled) of the first and second TFTs 281, 291 are connected to a corresponding data line Dj (1≦j≦n). A source electrode (not labeled) of the first TFT 281 is connected to one electrode (not labeled) of the first storage capacitor 283 and one electrode (not labeled) of the first liquid crystal capacitor 282. A source electrode (not labeled) of the second TFT 291 is connected to one electrode (not labeled) of the second storage capacitor 293 and one electrode (not labeled) of the second liquid crystal capacitor 292. The other electrode (not labeled) of the first storage capacitor 283 is connected to a corresponding first common line ComA, and the other electrode (not labeled) of the second storage capacitor 293 is connected to a corresponding second common line ComB. The other electrode (not labeled) of the first liquid crystal capacitor 282 and the other electrode (not labeled) of the second liquid crystal capacitor 292 are connected to a common electrode (not labeled).

The gate line G1 is used for applying a scanning signal to the first and second TFTs 281, 291 in order to switch on or switch off the first and second TFTs 281, 291. The data line Dj is used for applying a gray scale voltage to the drain electrodes of the first and second TFTs 281, 291 when the first and second TFTs 281, 291 are switched on. The first and second TFTs 281, 291 are switched on when receiving a high-level scanning signal, and are switched off when receiving a low-level scanning signal. The first common line ComA is used for applying a first common signal to the first storage capacitor 283, and the second common line ComB is used for applying a second common signal to the second storage capacitor 293. The first and second common signals are pulse voltage signals having different starting pulse times, and an amplitude value range of the pulse voltages is 0.5V˜5V.

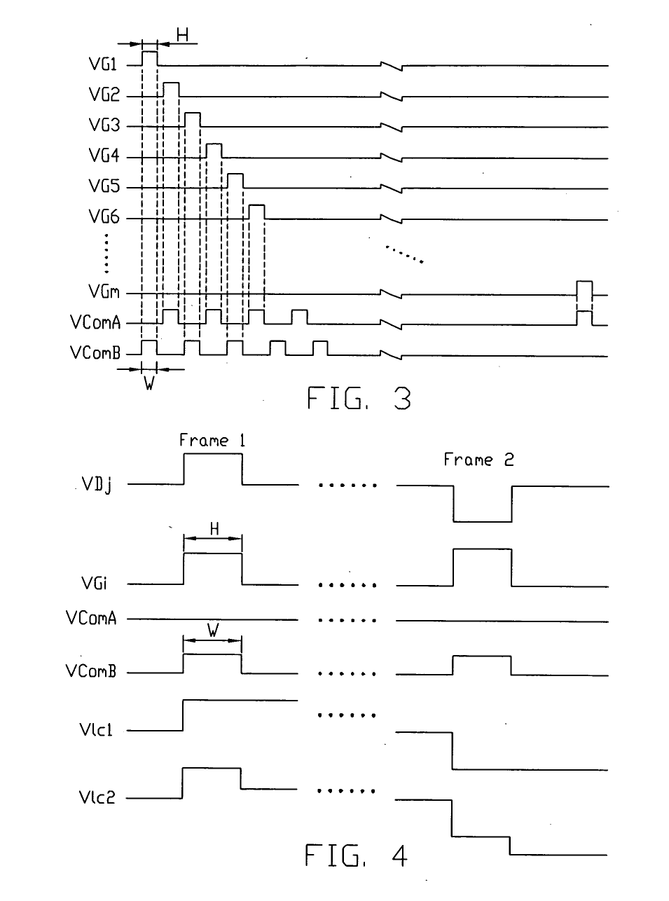

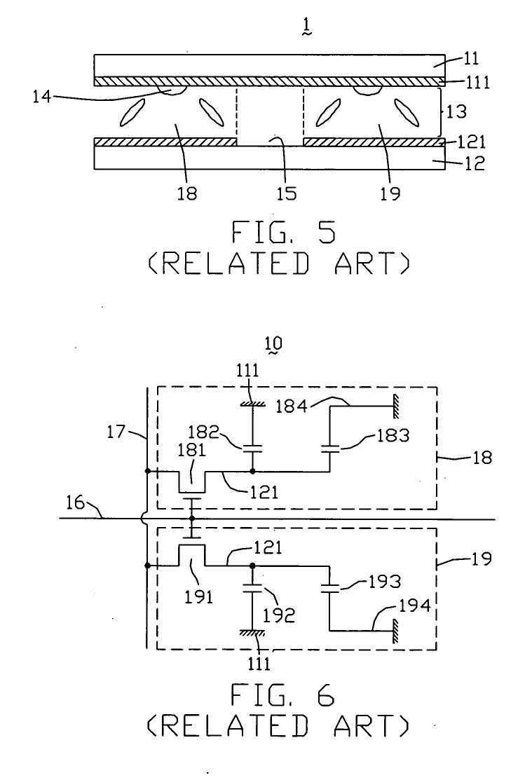

Referring also to FIG. 3, this is an abbreviated timing diagram illustrating waveforms of the scanning signals applied to the gate lines, and waveforms of the first and second common signals applied to the first and second common lines ComA, ComB. VG1˜VGm represent the scanning signals applied to the gate lines G1˜Gm, respectively. VComA represents the first common signal applied to the first common lines ComA. VComB represents the second common signal applied to the first common lines ComB.

In each frame, the gate lines G1˜Gm are scanned one by one successively. The period between the time when the scanning signal of a gate line changes from a low-level scanning voltage to a high-level scanning voltage and the time when the scanning signal of the gate line changes from the high-level scanning voltage to the low-level scanning voltage defines a scanning duration H. When the gate line G1 is scanned, the scanning signal VG1 changes from a low-level scanning voltage to a high-level scanning voltage, the first common signal VComA remains at a reference voltage, and the second common signal VComB generates a pulse voltage. When the scanning signal VG1 changes from the high-level scanning voltage to the low-level scanning voltage, the second common signal VComB changes from the pulse voltage to the reference voltage. Thus a pulse width W of the pulse voltage of the second common signal VComB is equal to the scanning duration H of the gate line G1. When the gate line G2 is scanned, the scanning signal VG2 changes from the low-level scanning voltage to the high-level scanning voltage, the first common signal VComA generates a pulse voltage, and the second common signal VComB remains at the reference voltage. When the scanning signal VG2 changes from the high-level scanning voltage to the low-level scanning voltage, the first common signal VComA changes from the pulse voltage to the reference voltage. A pulse width W of the pulse voltage of the first common signal VComA is equal to the scanning duration H of the gate line G2. Thereafter, changes in the first and second common signals VComA, VComB occur according to corresponding changes in the scanning signals VG for the following gate lines G after the gate line G2, repeating the pattern as described above.

Referring also to FIG. 4, an abbreviated timing diagram illustrating waveforms of driving signals applied to the pixel unit 20 is shown. VDj represents a gray scale voltage applied to the pixel unit 20 during two successive frames, namely Frame 1 and Frame 2. VGi represents the scanning signal applied to the pixel unit 20. VComA represents the first common signal applied to the first storage capacitor 283. VComB represents the second common signal applied to the second storage capacitor 293. V1c1 represents a voltage difference on the first liquid crystal capacitor 282. V1c2 represents a voltage difference on the second liquid crystal capacitor 292.

In Frame 1, when the gate line G1 is scanned, the gate line G1 has the scanning signal Vgi applied thereto. The scanning signal VGi is a high-level scanning voltage in the scanning duration H, and the corresponding first and second TFTs 281, 291 connected to the gate line G1 are switched on. The gray scale voltage VDj is applied to the drain electrodes of the first and second TFTs 281, 291. The first common signal VComA as a first voltage is applied to the first sub-pixel unit 28, and the second common signal VComB as a second voltage is applied to the second sub-pixel unit 29. A value of the first voltage is equal to a value of the reference voltage. A value of the second voltage is equal to the amplitude value of the pulse voltage. Then, the voltage difference V1c1 on the first liquid crystal capacitor 282 is equal to VDj-VComA. When the scanning signal VGi changes from the low-level scanning voltage to the high-level scanning voltage, the voltage difference V1c2 on the second liquid crystal capacitor 292 is equal to VDj, and the voltage difference on the second storage capacitor 293 is equal to VDj-VComB. When the scanning signal VGi changes from the high-level scanning voltage to the low-level scanning voltage, the second common signal VComB applied to the second sub-pixel unit 29 changes to the reference voltage, and the voltage difference V1c2 on the second liquid crystal capacitor 292 is equal to VDj-VComB. In Frame 2 and the following frames, the signals for driving the pixel unit 20 change according to the same pattern as that described above.

In one example, the reference voltage is 0V, and the amplitude value of the pulse voltage is +2.5V. In Frame 1, if VDj=+4V, when the gate line G1 has the scanning signal VGi applied thereto, V1c1=VDj−VComA=4−0=4V. When the scanning signal VGi changes from the low-level scanning voltage to the high-level scanning voltage, V1c2=VDj=4V, and the voltage difference on the second storage capacitor 293 is equal to VDj-VComB=4−2.5=1.5V. When the scanning signal VGi changes from the high-level scanning voltage to the low-level scanning voltage, the second common signal VComB applied to the second sub-pixel unit 29 changes to the reference voltage, V1c2=VDj−VComB=4−2.5=1.5V. In Frame 2, if VDj=−5V, when the gate line Gm has the scanning signal Vgi applied thereto, V1d1=VDj−VComA=−5−0=−5V. When the scanning signal VGi changes from the low-level scanning voltage to the high-level scanning voltage, V1c2=VDj=−5V, and the voltage difference on the second storage capacitor 293 is equal to VDj−VComB=−5−2.5=−7.5V. When the scanning signal VGi changes from the high-level scanning voltage to the low-level scanning voltage, the second common signal VComB applied to the second sub-pixel unit 29 changes to the reference voltage, V1c2=VDj−VComB=−5−2.5=−7.5V.

In summary, because the first and second common lines ComA, ComB apply the different common voltages to the first and second sub-pixel units 28, 29 respectively in each frame, the voltage difference on an area of a liquid crystal layer corresponding to the first sub-pixel unit 28 is different from the voltage difference on an area of the liquid crystal layer corresponding to the second sub-pixel unit 29. Thus, liquid crystal molecules of the liquid crystal layer corresponding to the first and second sub-pixel units 28, 29 are inclined at different angles, and the liquid crystal display 2 can reduce or even eliminate any color shift that may otherwise occur.

It is to be further understood that even though numerous characteristics and advantages of the present embodiments have been set out in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A liquid crystal display device comprising:
a plurality of gate lines configured for providing a plurality of scanning signals;
a plurality of data lines configured for providing a plurality of gray scale voltages;
a plurality of pixel units arranged in an array, each pixel unit comprising a first sub-pixel unit and a second sub-pixel unit, the first and second sub-pixel units being connected to one of the gate lines and one of the data lines;
a plurality of first common lines configured for providing a first common signal to the first sub-pixel units; and
a plurality of second common lines configured for providing a second common signal to the second sub-pixel units;
wherein the first and second common signals are pulse voltage signals and have different starting pulse times according to successive starting pulse times of the scanning signals.

2. The liquid crystal display device of claim 1, wherein the first and second common signals comprise a reference voltage and a pulse voltage, and when the first sub-pixel unit has the pulse voltage applied thereto, the second sub-pixel unit has the reference voltage applied thereto, and when the second sub-pixel unit has the pulse voltage applied thereto, the first sub-pixel unit has the reference voltage applied thereto.

3. The liquid crystal display device of claim 2, wherein a period between the time when the scanning signal of one of the gate lines changes from a low-level scanning voltage to a high-level scanning voltage and the time when the scanning signal of the gate line changes from the high-level scanning voltage to the low-level scanning voltage defines a scanning duration, and a pulse width of the pulse voltage is equal to the scanning duration of the gate line.

4. The liquid crystal display device of claim 3, wherein the first common lines and the second common lines are disposed alternately, and one of the gate lines is disposed between each two adjacent first and second common lines.

5. The liquid crystal display device of claim 4, wherein each of the pixel units is defined by the area between one of the first common lines, one of the second common lines adjacent to the first common line, and adjacent two data lines.

6. The liquid crystal display device of claim 5, wherein an amplitude of the pulse voltage is in the range of 0.5V˜5V.

7. The liquid crystal display device of claim 6, wherein the first sub-pixel unit comprises a first thin film transistor and a first storage capacitor, the second sub-pixel unit comprises a second thin film transistor and a second storage capacitor; the first and second thin film transistors each comprise a gate electrode, a drain electrode, and a source electrode; the first and second storage capacitors each comprise two electrodes; the gate electrodes of the first and second thin film transistors are coupled to the gate line, the drain electrodes of the first and second thin film transistors are coupled to one of the data lines, the source electrodes of the first and second thin film transistors are coupled to one electrode of the first and second storage capacitors, respectively; and the other electrodes of the first and second storage capacitors are connected to the first common line and the second common line, respectively.

8. The liquid crystal display device of claim 7, wherein an area ratio of the first sub-pixel unit relative to the second sub-pixel unit is 1:3.

9. A liquid crystal display device comprising:
a plurality of gate lines configured for providing a plurality of scanning signals;
a plurality of data lines configured for providing a plurality of gray scale voltages;
a plurality of pixel units arranged in an array, each pixel unit comprising a first sub-pixel unit and a second sub-pixel unit, the first and second sub-pixel units being connected to one of the gate lines and one of the data lines;
a plurality of first common lines configured for providing a first common signal to the first sub-pixel units; and
a plurality of second common lines configured for providing a second common signal to the second sub-pixel units;
wherein the first and second common signals are pulse voltage signals, and when a scanning signal is provided to one of the gate lines, a pulse voltage of the first common signal is generated, and when a scanning signal is provided to a next adjacent one of gate lines, a pulse voltage of the second common signal is generated.

10. The liquid crystal display device of claim 9, wherein a period between the time when the scanning signal of one of the gate lines changes from a low-level scanning voltage to a high-level scanning voltage and the time when the scanning signal of the gate line changes from the high-level scanning voltage to the low-level scanning voltage defines a scanning duration, and a pulse width of the pulse voltage of each of the first and second common signals is equal to the scanning duration of the gate line.

11. A method for driving a liquid crystal display device, the method comprising:
providing a plurality of pixel units arranged in an array, each pixel unit comprising a first sub-pixel unit and a second sub-pixel unit;
providing a plurality of gate lines, a plurality of data lines, a plurality of first common lines, and a plurality of second common lines, with each of the pixel units connected to one of the gate lines, one of the data lines, one of first common lines, and one of second common lines;
providing a plurality of scanning signals to the pixel units via the gate lines;
providing a plurality of gray scale voltages to the pixel units via the data lines;
providing a first common signal to the first sub-pixel units via the first common lines; and
providing a second common signal to the second sub-pixel units via the second common lines;
wherein the first and second common signals are pulse voltage signals and have different starting pulse times according to successive starting pulse times of the scanning signals.

12. The method of claim 11, wherein in each frame, the gate lines are scanned one by one successively.

13. The method of claim 12, wherein a period between the time when the scanning signal of a gate line changes from a low-level scanning voltage to a high-level scanning voltage and the time when the scanning signal of the gate line changes from the high-level scanning voltage to the low-level scanning voltage defines a scanning duration; and when one of the gate lines is scanned, the scanning signal changes from a low-level scanning voltage to a high-level scanning voltage, the first common signal remains at a reference voltage, and the second common signal generates a pulse voltage, and when the scanning signal changes from the high-level scanning voltage to the low-level scanning voltage, the second common signal changes from the pulse voltage to the reference voltage.

14. The method of claim 13, wherein a pulse width of the pulse voltage of the second common signal is equal to the scanning duration of the gate line.

15. The method of claim 14, wherein when a next adjacent one of the gate lines is scanned, a corresponding next scanning signal changes from the low-level scanning voltage to the high-level scanning voltage, the first common signal generates a pulse voltage, and the second common signal remains at the reference voltage, and when the next scanning signal changes from the high-level scanning voltage to the low-level scanning voltage, the first common signal changes from the pulse voltage to the reference voltage.

16. The method of claim 15, wherein a pulse width of the pulse voltage of the first common signal is equal to the scanning duration of the next gate line.
